(19) United States
(12) Patent Application Publication
(10) Pub. No.: US 2010/0203424 A1
(43) Pub. Date: Aug. 12, 2010

(54) CORROSION RESISTANT FILM FOR FUEL CELL SEPARATOR AND FUEL CELL SEPARATOR

(75) Inventors: YOSHINORI ITO, KOBE-SHI (JP); TOSHIKI SATO, KOBE-SHI (JP); JUN SUZUKI, KOBE-SHI (JP); JUN HISAMOTO, KOBE-SHI (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA KOBE SEIKO SHO(KOBE STEEL, LTD.), KOBE-SHI (JP)

(21) Appl. No.: 12/615,377

(22) Filed: Nov. 10, 2009

(30) Foreign Application Priority Data
Feb. 6, 2009 (JP) 2009-026749

(51) Int. Cl. H01M 2/00

(52) U.S. Cl. 429/509

(57) ABSTRACT

The present invention provides: a corrosion resistant film that yields the effect of keeping a low contact resistance for an extended period of time by covering the surface of a fuel cell separator and is excellent in productivity at a low cost; and a separator using the corrosion resistant film. A separator according to the present invention has a corrosion resistant film formed by laminating a corrosion resistant layer and a conductive layer comprising one or more kinds of noble metal elements selected from the group of Au and Pt on the surface of a substrate comprising a metallic material such as Ti, Al, or SUS. The corrosion resistant layer: comprises an alloy of one or more kinds of noble metal elements selected from the group of Au and Pt and one or more kinds of normoble metal elements selected from the group of Nb, Ta, Zr, and Hf; and contains the normoble metal elements by 50 to 90 atomic %. An amorphous alloy is thereby formed, pinholes hardly appear even when the film is formed by an ordinary sputtering method or the like, and the substrate is not exposed. By forming such a corrosion resistant layer as the foundation layer, the separator can reduce the thickness of the conductive layer on the surface and the cost.

### FIELD OF THE INVENTION

The present invention relates to: a film to cover the surface of a fuel cell separator used for a fuel cell and render corrosion resistance; and a fuel cell separator using the film.

### BACKGROUND OF THE INVENTION

A fuel cell capable of continuously extracting electric power by continuing to supply a fuel such as hydrogen and an oxidant such as oxygen is expected as an energy source to cover various applications and sizes because the fuel cell has a high electrical efficiency, a low noise, and a low vibration without being influenced much by the size of the system unlike a primary battery such as a dry battery and a secondary battery such as a lead battery. More specifically, a fuel cell is developed as a polymer electrolyte fuel cell (PEFC), an alkaline electrolyte fuel cell (AFC), a phosphoric acid fuel cell (PAFC), a molten carbonate fuel cell (MCFC), a solid oxide fuel cell (SOFC), a biofuel cell, or the like. Among those, the development of a polymer electrolyte fuel cell is promoted for the applications to a fuel-cell-powered vehicle, a domestic cogeneration system, a portable phone, and a personal computer.

A polymer electrolyte fuel cell (hereunder referred to as “fuel cell”) is configured by: using a substance formed by interposing a polymer electrolyte film between an anode and a cathode as a single cell; and overlapping the plurality of single cells while interposing a separator (also called “a bipolar plate”) having grooves acting as the flow paths of gases (hydrogen, oxygen, and the like).

A separator is required to have a high strength and a high workability in order to reduce the thickness of the separator and thereby reduce the thickness and weight of a fuel cell. Further, since a separator is also a part to extract electric current generated in a fuel cell to an exterior, a material for the separator is required to have the characteristics of a low contact resistance (that means that voltage drop occurs between an electrode and a separator surface because of an interface phenomenon) and long lasting of the low contact resistance during the use of the material as the separator. Moreover, the interior of a fuel cell is in an acidic atmosphere of about 2 to 4 in pH and hence a separator is required to have a high corrosion resistance. In order to satisfy the requirements, a separator to which corrosion resistance and electrical conductivity are given by: using a metallic material, such as aluminum, titanium, nickel, an alloy based on those, or a stainless steel, having a low resistance and being excellent in workability and strength as the substrate; and coating the metallic material with a noble metal such as gold (Au) has heretofore been studied.

For example, JP-A No. 228914/1998 describes a separator formed by applying gold plating 10 to 60 nm in thickness on the surface of a substrate comprising a stainless steel. Further, JP-A No. 6713/2001 describes a separator formed by: using a stainless steel or titanium material as the substrate; and depositing a noble metal such as Au or a noble metal alloy 5 nm or more in thickness on the surface thereof, or removing an oxide film on the substrate surface and thereafter depositing a noble metal or a noble metal alloy. Furthermore, JP-A No. 93538/2001 describes, in order to reduce the quantity of a used noble metal, a separator formed by: removing an oxide film on the surface of a substrate comprising a stainless steel; thereafter forming an acid-resistant film comprising a normoble metal such as Ta, Zr, or Nb; and thereon forming an electrically conductive film 0.1 μm or less in thickness comprising a noble metal selected from the group of Au, PT, and Pd. Meanwhile JP-A No. 185998/2004 describes a separator formed by laminating an intermediate layer comprising an element selected from the group of Ti, Zr, Hf, Nb, Ta, and others and an electrically conductive film comprising carbon on a substrate comprising a metal such as stainless steel or aluminum while the oxide film of the substrate remains.

In the case of a separator described in JP-A Nos. 228914/1998 and 6713/2001 however, when the separator is exposed in a severe acidic atmosphere of a strong acidity, a high temperature, and a high pressure in the interior of a fuel cell, an Au film on the surface may coagulate and peel off in some cases. As a result, a substrate is exposed and the electrical conductivity may deteriorate considerably due to an oxide film formed on the substrate surface and others. Consequently, when such a separator is used for a fuel cell, although it is possible to lower a contact resistance at the beginning of use, it is concerned that the low contact resistance may not be kept for an extended period of time, the contact resistance may increase and current loss may appear with the lapse of time, and the performance of the fuel cell may deteriorate. It is further concerned that a substrate may corrode and a polymer electrolyte film may deteriorate due to eluted metallic ions.

Further, in the case of a separator described in JP-A Nos. 93538/2001 and 185998/2004, a sputtering method is named as a method for forming a film of a metal such as Ta, Zr, and Nb on a substrate. It is concerned however that, if such a high-melting-point metal is used for film forming by an ordinary sputtering method, a metallic film having pinholes may be formed and an exposed substrate may corrode.

### SUMMARY OF THE INVENTION

The present invention has been established in view of the above problems and an object of the present invention is to provide: a fuel cell separator that can keep a low contact resistance during prolonged use, can avoid increasing cost, and is excellent in productivity; and a film used for the fuel cell separator.

A separator that can keep electrical conductivity even in an acidic atmosphere can be obtained by coating a substrate with a noble metal such as Au or Pt having an excellent electrical conductivity and an excellent corrosion resistance, but a sufficient thickness is necessary for avoiding exposing the substrate and the cost increases. In the case of a film comprising pure Au in particular, if the thickness is reduced to 10 nm or less, coagulation occurs on a substrate and the substrate is exposed. Meanwhile, a normoble metal such as Ta excellent in corrosion resistance is a high-melting-point metal and hence pinholes tend to form when a film is formed by a sputtering method or the like. It is possible to inhibit pinholes from forming by increasing the film thickness or applying heat or bias to a substrate during film forming but any of the methods causes productivity to deteriorate. In addition, such a film forming method cannot be applied to a substrate comprising aluminum or aluminum alloy having a low high-temperature strength because of thermal deformation.

The present inventors have found that, when a noble metal element selected from the group of Au and Pt and a normoble metal element selected from the group of Nb, Ta, Zr, and Hf are alloyed at a prescribed ratio, the crystal comes to be amorphous, the amorphous alloy shows excellent corrosion resistance similar to the original metal elements, pinholes are not formed even when a thin film of a thickness of 10 nm or less for example is formed, the noble metal element does not coagulate, and hence the amorphous alloy film does not cause a substrate to be exposed. On this occasion, since electrical conductivity deteriorates due to the oxide film of the normoble metal element, a separator is formed by forming the amorphous alloy as a foundation layer to render corrosion resistance on the substrate surface and laminating the noble metal selected from the group of Au and Pt as a conductive layer on the foundation layer. In such a separator, even when Au or Pt coagulates in the conductive layer on the surface, the foundation layer having corrosion resistance is formed and hence the substrate is not exposed.

That is, a corrosion resistant film for a fuel cell separator according to the present invention that has solved the above problems is a film which covers the surface of the fuel cell separator, the film comprising: a corrosion resistant layer comprising an alloy of one or more kinds of noble metal elements selected from the group of Au and Pt and one or more kinds of normoble metal elements selected from the group of Nb, Ta, Zr, and Hf and containing the normoble metal elements by 50 to 90 atomic %; and a conductive layer being laminated on the corrosion resistant layer and comprising one or more kinds of noble metal elements selected from the group of Au and Pt.

By using an alloy having such a mixing ratio of one or more noble metal elements and one or more normoble metal elements as a corrosion resistant layer, an amorphous alloy is obtained, an excellent corrosion resistance withstanding a severe acidic atmosphere in the interior of a fuel cell is obtained, pinholes do not appear, no coagulation occurs, and thus a substrate is not exposed. Moreover, by forming a conductive layer with one or more noble metals on the corrosion resistant layer, it is possible to obtain an electrical conductivity necessary for a fuel cell separator. Further, since the substrate is prevented from being exposed by the corrosion resistant layer, it is not necessary to increase the thickness of the conductive layer.

In a corrosion resistant film for a fuel cell separator according to the present invention, the conductive layer may comprise an alloy further containing one or more kinds of normoble metal elements selected from the group of Nb, Ta, Zr, and Hf by not more than 65 atomic % in addition to the noble metal elements. By using an alloy containing one or more kind of normoble metal elements similarly to the corrosion resistant layer as the foundation layer in the range not hindering the electrical conductivity, it is possible to improve the adhesiveness to the corrosion resistant layer.

A fuel cell separator according to the present invention is formed by coating a substrate comprising one kind selected from the group of titanium, titanium alloy, aluminum, aluminum alloy, and stainless steel with the aforementioned corrosion resistant film for a fuel cell separator. A substrate comprising such a metallic material is excellent in workability and strength and suitable for a substrate for a fuel cell separator. Then in forming the corrosion resistant film for a fuel cell separator, even when a material such as aluminum having a low high-temperature strength is used as the substrate, the fuel cell separator can be produced easily without thermal deformation.

By a corrosion resistant film for a fuel cell separator according to the present invention, it is possible to produce a fuel cell separator that can keep a low contact resistance for an extended period of time by an ordinary sputtering method without specifying the material for a substrate. Then in a fuel cell separator according to the present invention, it is possible to produce a fuel cell separator that can keep a low contact resistance for an extended period of time at a low cost by forming a corrosion resistant film for a fuel cell separator on a substrate comprising a metal having workability and strength suitable for a separator.

### BRIEF DESCRIPTION OF THE DRAWINGS

FIG. 1 is a sectional view schematically showing the configuration of a fuel cell separator according to the present invention.

FIG. 2 is a schematic view explaining a measurement method of contact resistance.

### DETAILED DESCRIPTION OF THE PREFERRED EMBODIMENTS

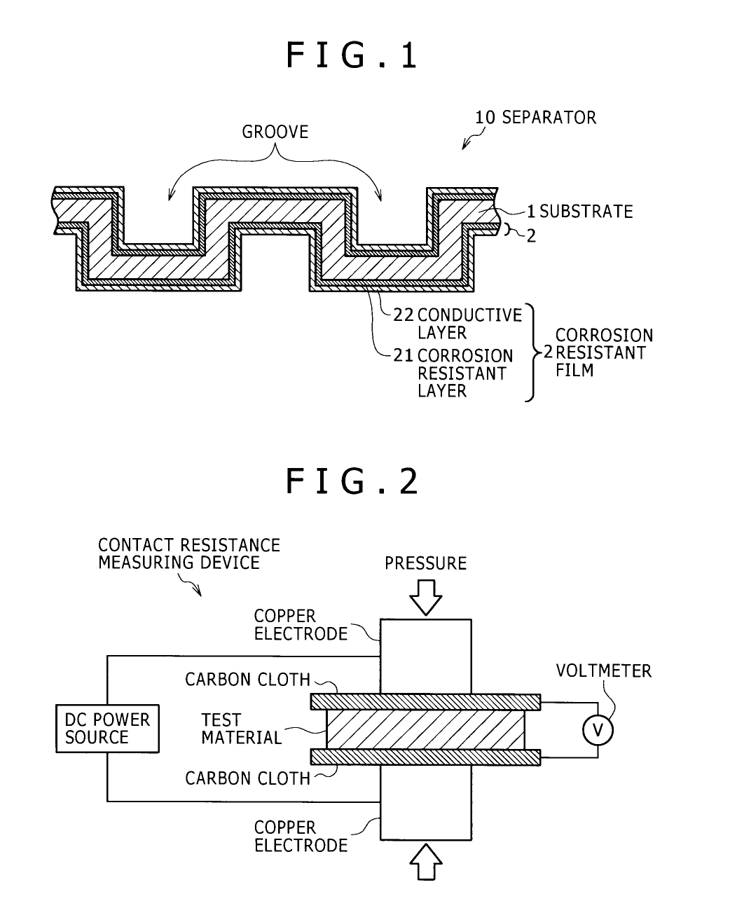

A corrosion resistant film for a fuel cell separator and a fuel cell separator according to the present invention are explained in detail. As shown in FIG. 1, a corrosion resistant film for a fuel cell separator (hereunder referred to as a corrosion resistant film) 2 according to the present invention constitutes a fuel cell separator (hereunder referred to as a separator occasionally) 10 according to the present invention by coating a substrate 1 with the corrosion resistant film 2. Further, the corrosion resistant film 2 comprises a laminated layer comprising a corrosion resistant layer 21 formed on the surface of the substrate 1 and a conductive layer 22 formed thereon. Each component is hereunder explained in detail.

### [Corrosion Resistant Film]

### (Corrosion Resistant Layer)

A corrosion resistant layer 21 comprises an alloy of one or more kinds of noble metal elements selected from the group of Au and Pt and one or more kinds of normoble metal elements selected from the group of Nb, Ta, Zr, and Hf and the content of the normoble metal elements is 50 to 90 atomic %. Nb, Ta, Zr, and Hf have corrosion resistance by forming a passive film and render excellent corrosion resistance to a separator 10 by coating the separator with a film comprising an alloy based on such one or more normoble metal elements. Meanwhile, Nb, Ta, Zr, and Hf are high-melting-point metals, the atoms of the metals hardly diffuse on a surface during film forming, and hence pinholes tend to appear in the metallic film. Pinholes can be prevented from forming by increasing the film thickness but the productivity of the film lowers. By using an alloy of them and noble metals Au and Pt and controlling the content of the normoble metal elements to 90 atomic % or less however, the crystal of the alloy comes to be amorphous and pinholes are not formed even when the film thickness is reduced to 3 nm or less. If the content of the normoble metal elements exceeds 90 atomic %, the alloy takes a crystal structure of the normoble metal elements Nb, Ta, Zr, and Hf. As long as the content of the normoble metal elements is 85 atomic % or less, most of the corrosion resistant layer 21 can preferably be occupied by amorphous alloy.

Au and Pt are noble metal elements having natures similar to each other, are transition metals, hence are excellent in electrical conductivity, are excellent in corrosion resistance even when a passive film is not formed, and hence can keep the electrical conductivity even in an acidic atmosphere. For that reason, the noble metal elements are contained in a conductive layer 22 that is described later and also in the corrosion resistant layer 21 and thereby Au and Pt also have the function of enhancing adhesiveness to the conductive layer 22. Moreover, when the content of the noble metal elements is 35 atomic % or more, the corrosion resistant layer 21 comes to have electrical conductivity but, on the other hand, the solid solution of Au and Pt tends to separate, a phase interface with an amorphous phase is formed, and pinholes may appear when the thickness of the corrosion resistant layer 21 is as thin as 5 nm or less. In addition, when the content of the noble metal elements exceeds 50 atomic %, namely when the content of the normoble metal elements is less than 50 atomic %, in the corrosion resistant film 2 of a separator 10, in the case where the thickness of the corrosion resistant layer 21 is 10 nm or less in particular, the noble metal elements coagulate, a substrate 1 is exposed, and corrosion cannot be prevented during long time use. Consequently, the content of the normoble metal elements in the corrosion resistant layer 21 is set at 50 to 90 atomic %, preferably in excess of 65 atomic % and not more than 90 atomic %, and yet preferably in excess of 65 atomic % and not more than 85 atomic %. Here, the thickness of the corrosion resistant layer 21 is not particularly limited but the thickness is preferably 2 nm or more in order to render a sufficient corrosion resistance to the separator 10, but the effects are saturated and the productivity lowers if it is too thick and hence a yet preferable thickness is 50 nm or less.

### (Conductive Layer)

A conductive layer 22 comprises one or more kinds of noble metal elements selected from the group of Au and Pt. As stated above, the noble metal elements Au and Pt can keep electrical conductivity even in an acidic atmosphere. Consequently, by forming the conductive layer 22 with the noble metal elements Au and Pt or an Au—Pt alloy, the conductive layer 22 can keep electrical conductivity even in a severe acidic atmosphere in the interior of a fuel cell. Here in the corrosion resistant film 2 of a separator 10, when the thickness of the conductive layer 22 is 10 nm or less in particular, the noble metal elements may coagulate during long time use in some cases but, since a corrosion resistant layer 21 is formed as the foundation layer, the substrate 1 is not exposed and corrosion can be prevented.

The conductive layer 22 may comprise an alloy formed by adding one or more kinds of normoble metal elements selected from the group of Nb, Ta, Zr, and Hf by 65 atomic % or less to the noble metal elements. Since the normoble metal elements are contained in the aforementioned corrosion resistant layer 21, the normoble metal elements have the function of further enhancing the adhesiveness to the corrosion resistant layer 21 by adding the normoble metal elements also to the conductive layer 22. In order to make the effect enhanced, the content of the normoble metal elements is preferably 5 atomic % or more and the adhesiveness improves as the addition amount increases. On the other hand, as the content of the normoble metal elements increases, the electrical conductivity lowers because of the passive film of the normoble metal elements. Consequently, the content of the normoble metal elements is set at 65 atomic % or less and preferably at 60 atomic % or less. Here, the thickness of the conductive layer 22 is not particularly limited but the thickness is preferably 2 nm or more in order to render a sufficient electrical conductivity to a separator 10. If the thickness of the conductive layer 22 is too thick however, the effects are saturated and the cost increases. Consequently a yet preferable thickness is 50 nm or less.

The noble metal elements contained in the corrosion resistant layer 21 and the conductive layer 22 may be either an identical element or elements different from each other (for example, Au is contained in the corrosion resistant layer 21 and Pt is contained in the conductive layer 22). In the same way, a normoble metal element added to the conductive layer 22 may not be the same normoble metal element as contained in the corrosion resistant layer 21. When the corrosion resistant film 2 is formed on a substrate 1, the corrosion resistant layer 21 and the conductive layer 22 are continuously formed preferably by a PVD method as it is described later. On this occasion, by using the same noble metal element and normoble metal element for the corrosion resistant layer 21 and the conductive layer 22 respectively, it is possible to minimize the number of the film materials (sputtering targets and others) prepared for a PVD apparatus and the number of kinds of the noble metal elements and the normoble metal elements can be reduced to one kind each, namely two kinds in total, and hence that is preferable from the viewpoint of productivity and the simplification of the apparatus.

It is preferable to form the corrosion resistant film 2 on the substrate 1 by a PVD method by which the corrosion resistant film can be formed at ordinary temperature because it is possible to: reduce damages (warping, deterioration of strength, and others) to the substrate 1; form the corrosion resistant layer 21 and the conductive layer 22 continuously; form the film to a relatively large area; and improve productivity. As a PVD method, a sputtering method, a vapor deposition method, an ion plating method, and other methods are named and in particular a sputtering method is appropriate because the compositions and thicknesses of the corrosion resistant layer 21 and the conductive layer 22 can easily be controlled individually. In an example of the sputtering method, it is possible to continuously form the corrosion resistant layer 21 and the conductive layer 22 having different compositions by: attaching a noble metal target and a normoble metal target to respective electrodes of a sputtering apparatus; varying the outputs of the targets (electrodes) respectively; and thereby applying sputtering. As another method, it is also possible to apply sputtering by: attaching alloy targets (and noble metal targets) conditioned in conformity with the alloys (and noble metals) constituting the corrosion resistant layer 21 and the conductive layer 22 to respective electrodes; and switching the electrodes for outputting.

### [Separator]

### (Substrate)

To a substrate 1 of a separator 10 according to the present invention, a material excellent in corrosion resistance such as titanium or titanium alloy or a material showing insufficient corrosion resistance in a severe acidic atmosphere in the interior of a fuel cell such as aluminum, aluminum alloy, or stainless steel including SUS304 and SUS316 can be applied. Aluminum or stainless steel is desirable from the viewpoint of cost. On the substrate 1, it is possible to form a corrosion resistant film 2 (a corrosion resistant layer 21) without removing an oxide film (a passive film) on the surface. Further, it is possible to preferably form the passive film stably on the surface of the substrate 1 by applying pickling treatment before forming the corrosion resistant film 2. In a substrate 1 comprising a material containing Fe, such as a stainless steel in particular, when after-mentioned heat treatment is applied after forming the corrosion resistant film 2 and an oxide film is not formed, Fe in the substrate 1 may undesirably diffuse in the corrosion resistant film 2 (the corrosion resistant layer 21 and the conductive layer 22) and moreover up to the surface. The elution of Fe from the surface of a separator 10 deteriorates a polymer electrolyte film in the interior of a fuel cell.

The thickness of a substrate 1 is not particularly limited but, when a stainless steel is used for example, a preferable thickness is 0.05 to 0.5 mm as the substrate of a separator 10 for a fuel cell. By setting the thickness of the substrate 1 in the range, it is possible to satisfy the requirements of weight reduction and thickness reduction for the separator 10, facilitate processing for such a thickness relatively, and obtain strength and handleability as a plate. The substrate 1 can be produced by a known method; by obtaining a desired thickness in hot rolling, cold rolling, and the like, thereafter conditioning the material in annealing or the like if necessary, obtaining a desired shape by press forming or the like, and forming grooves functioning as gas flow paths.

### [Production Method of Separator]

A separator 10 according to the present invention is preferably produced by: producing a substrate 1 as stated above; forming a corrosion resistant film 2 (a corrosion resistant layer 21 and a conductive layer 22) on the surface (at least on one surface) of the substrate 1; and thereafter applying heat treatment at a temperature of 200° C. to 800° C. By applying the heat treatment in the temperature range, elements interdiffuse between the substrate 1 (or the oxide film of the substrate 1) and the corrosion resistant layer 21 and between the corrosion resistant layer 21 and the conductive layer 22, the adhesiveness between them improves, and the electrical conductivity also improves.

If the temperature is low at the heat treatment, the elements interdiffuse insufficiently and the aforementioned effects are not sufficiently obtained. Consequently, the heat treatment temperature is set at 200° C. or higher and preferably 300° C. or higher. In contrast, if the heat treatment temperature is too high, the interdiffusion of the elements is too fast and excessive, the noble metal element reduces and the area ratio of the passive film of the normoble metal element increases on the uppermost surface, namely the surface of the conductive layer 22, of the separator 10, and the contact resistance increases. Further, in the case of using a stainless steel or the like as the substrate 1, undesirably the oxide film on the surface may disappear and Fe in the substrate 1 may diffuse up to the uppermost surface of the separator 10. Consequently, the heat treatment temperature is set at 800° C. or lower, preferably 650° C. or lower, and yet preferably 600° C. or lower. Moreover, even when the heat treatment temperature is in the range, if the heat treatment is applied for an extended period of time, the interdiffusion of the elements is excessive and hence it is preferable to properly adjust the heat treatment time in accordance with the heat treatment temperature. For example, when the heat treatment temperature is about 500° C., a preferable heat treatment time is 1 to 5 minutes.

Further, if the partial pressure of oxygen is lowered in the heat treatment, the normoble element contained in the corrosion resistant layer 21 or also in the conductive layer 22 is hardly oxidized by the heat treatment, hence the electrical conductivity of the layers does not lower, the corrosion resistant film 2 hardly peels off, and a separator 10 for a fuel cell that is excellent in acid resistance and electrical conductivity and keeps a low contact resistance for an extended period of time can be produced. More specifically, it is preferable to apply heat treatment at 0.01 Pa or less. Consequently, with regard to heat treatment, any heat treatment furnace, such as an electric furnace, a gas furnace, or another furnace, can be used as long as the heat treatment furnace can apply heat treatment at least at a heat treatment temperature of 200° C. to 800° C. and preferably can adjust the atmosphere.

Configurations to carryout the present invention have heretofore been explained on a fuel cell separator and a corrosion resistant film thereof according to the present invention, and examples confirming the effects of the present invention are explained hereunder in comparison with comparative examples that do not satisfy the requirements of the present invention. Here, it goes without saying that the present invention is not limited to the examples and the above configurations however, and various changes and modifications based on the descriptions are also included in the tenor of the present invention.

### EXAMPLES

### Production of Substrate

A test material of a fuel cell separator is produced as follows. Firstly, a substrate is produced by cutting a cold-rolled sheet (0.1 mm in thickness) of SUS316L into the size of 20 mm×50 mm, applying acetone ultrasonic cleaning thereto, and further pickling it in a mixed solution of hydrofluoric acid and nitric acid.

### (Forming Corrosion Resistant Film)

A test material of a fuel cell separator is produced with the obtained substrate. With regard to the components of metals or alloys used for forming a corrosion resistant layer and a conductive layer, Au is adopted as a noble metal element and Ta is adopted as a normoble metal element. An Au target and a Ta target are attached to respective electrodes in a magnetron sputtering apparatus, the substrate is mounted at a position of a height where the normal lines of both the targets intersect with each other in a chamber, and thereafter the air is evacuated to a vacuum of 0.0013 Pa or less in the chamber. Successively, Ar gas is introduced into the chamber and the pressure in the chamber is adjusted to 0.27 Pa. Thereafter, prescribed outputs are imposed onto the Au target and the Ta target respectively from a DC power source, thus Ar plasma is generated, thereby sputtering is applied, a corrosion resistant layer 5 nm in thickness having an intended composition is formed on the surface (one surface) of the substrate, successively a conductive layer 5 nm in thickness is formed by changing the composition, and resultantly a corrosion resistant film is formed. Here, in the cases of the test materials Nos. 1, 2, 4, and 16, the same composition is applied to both a corrosion resistant layer and a conductive layer and a film (a corrosion resistant film) 10 nm in thickness is formed by one-time sputtering. Successively, the chamber is once opened, the substrate is reversed, a film is formed also on the other surface so that the compositions of the corrosion resistant layer and the conductive layer may be identical to the compositions of the respective layers on the top surface in the same way as the surface, and resultantly a corrosion resistant film is formed. Here in the series of sputtering, heating and bias impression to the substrate are not applied. With regard to the corrosion resistant layer and the conductive layer, the compositions (ratios of contents) are controlled by changing the respective outputs (sputter speeds) of the Au target and the Ta target and the film thickness is controlled by changing the film forming time. Here, the compositions of the corrosion resistant layer and the conductive layer are measured by the method described below and the contents of Ta are shown in Table 1.

### (Heat Treatment)

Fuel cell separator test materials Nos. 1 to 16 are obtained by applying heat treatment to the substrates on both the surfaces of which corrosion resistant films are formed at 500° C. for 5 minutes in a vacuum atmosphere of 0.00665 Pa. Further, as test materials for the evaluation of the adhesiveness of a corrosion resistant film that is described later, test materials produced by forming only corrosion resistant layers on both the surfaces of a substrate are formed (test materials for the evaluation of a corrosion resistant layer) are prepared from the test materials Nos. 3 and 5 to 15 and heat treatment is applied to the test materials in the same way. With regard to the obtained test materials, the adhesiveness, electrical conductivity, and corrosion resistance of a corrosion resistant film are evaluated.

### (Measurement of Compositions of Corrosion Resistant Layer and Conductive Layer)

Each of the compositions of the corrosion resistant layer and the conductive layer of each test material is measured by using a sample produced by forming either a corrosion resistant layer or a conductive layer on one surface of a polycarbonate (PC) substrate under the same film forming condition (respective outputs of an Au target and a Ta target). The corrosion resistant layer or the conductive layer on the PC substrate is dissolved by immersing the sample in an acid solution prepared by mixing hydrochloric acid, nitric acid, and hydrofluoric acid in the proportion of 3 ml to 1 ml to 0.1 ml and heating the acid solution to 80° C. After the obtained solution is cooled to the ordinary temperature, each of the concentrations of Au and Ta in the solution is measured by ICP (Inductively Coupled Plasma) emission spectroscopy. The percentage of a Ta concentration to the sum of an Au concentration and the Ta concentration is computed as a Ta content (atomic %).

### (Evaluation of Electrical Conductivity)

The contact resistance of a test material is measured with a contact resistance measuring device shown in FIG. 2.

As shown in FIG. 2, a resistance value is computed by: interposing a test material between two sheets of carbon cloth from both sides; loading a pressure of 98 N (10 kgf) on the test material from the outside with copper electrodes 1 cm² in contact area; applying an electric current of 7.4 mA to the test material with a DC power source; and measuring the voltage imposed between the two carbon cloth sheets with a voltmeter. The obtained resistance values are shown in Table 1 as the contact resistances in the initial characteristics. With regard to the acceptance criterion of electrical conductivity, a case where the contact resistance of a test material after immersed in a sulfuric acid aqueous solution used for after-mentioned corrosion resistance evaluation for 100 hours is 10 mΩ·cm² or less is evaluated as acceptable.

### (Evaluation of Adhesiveness)

The adhesiveness of the corrosion resistant film of a test material is evaluated with the contact resistance measuring device (refer to FIG. 2) used for the measurement of contact resistance.

Firstly, each of the respective surfaces (respective corrosion resistant layer surfaces and respective conductive layer surfaces) of a test material for corrosion resistant layer evaluation and a test material is subjected to X-ray photoelectron spectrometry with a fully automatic scanning type X-ray photoelectron spectrometer (QuanteraSMX, made by Physical Electronics Inc.) and an Au (the vicinity of a binding energy of 85 eV) concentration is measured at a position 2 nm in depth from the surface. The measurement conditions of the X-ray photoelectron spectrometry are as follows; X-ray source: monochromatic Al-Kα, X-ray output: 44.8 W, X-ray beam diameter: 200 μm, photoelectron takeoff angle: 45°, and Ar′ sputter speed: about 4.6 nm/min in SiO₂ equivalent. Further, an Au concentration is obtained by averaging Au concentrations measured similarly in three visual fields. Successively, in the same way as the measurement of a contact resistance, each of the test materials is interposed between two sheets of carbon cloth from both sides, a pressure of 98 N (10 kgf) is loaded on the test material further from the outside with copper electrodes 1 cm² in contact area, and the test material is extracted in an in-plane direction while the pressurized state is maintained (extraction test). Then an Au concentration on a surface (each of a corrosion resistant layer surface after extraction and a conductive layer surface after extraction) is measured in the same way as the measurement of an Au concentration before the extraction test.

From each of the measured Au concentrations, a corrosion resistant layer residual ratio is computed as adhesiveness between a corrosion resistant layer and a substrate, and a conductive layer residual ratio is computed as adhesiveness between a conductive layer and a corrosion resistant layer. More specifically, the Au concentration on a corrosion resistant layer surface is regarded as 100% and the Au concentration on a corrosion resistant layer surface after extraction is converted into the corrosion resistant layer residual ratio. Further, the Au concentration on a corrosion resistant layer surface is regarded as 0% and the Au concentration on a conductive layer surface is regarded as 100%, and the Au concentration on a conductive layer surface after extraction is converted into the conductive layer residual ratio. The results are shown in Table 1. With regard to the acceptance criterion of adhesiveness, a case where the respective residual ratios of both a corrosion resistant layer and a conductive layer are 60% or more is evaluated as acceptable. Here, in the test materials Nos. 1, 2, 4, and 16, a corrosion resistant layer is formed on the surface of a test material and only a corrosion resistant layer residual ratio is computed. Further, in the test material No. 3, the corrosion resistant layer residual ratio does not satisfy the acceptance criterion and hence the conductive layer residual ratio is not measured.

### (Evaluation of Corrosion Resistance)

After the edge of a test material where no corrosion resistant film is formed is masked, the test material is immersed for 100 hours in a sulfuric acid aqueous solution of pH 2 heated to 80° C. On this occasion, the solution volume to specimen area is set at 20 ml/cm². The contact resistance of a test material after immersed in the sulfuric acid aqueous solution is measured by the same method as the case of a test material before immersion and the results are shown in Table 1. Further, an Fe concentration in the sulfuric acid aqueous solution after used for the immersion of the test material is measured by the ICP emission spectroscopy and the Fe concentration is converted into the quantity of eluted Fe per test area, and the results are shown in Table 1. With regard to the acceptance criterion of corrosion resistance, a case where the contact resistance is 10 mΩ·cm² or less and the eluted Fe quantity is 5 mg/m² or less after a test material is immersed for 100 hours in a sulfuric acid aqueous solution is evaluated as acceptable.

TABLE 1

| | | | | | | | Characteristic | |
|---|---|---|---|---|---|---|---|---|
| | | Corrosion resistant film | | Initial characteristic | | | after sulfuric | |
| | | Corrosion | | Corrosion | | | acid immeresion | |
| | | resistant | Conductive | resistant | Conductive | | | Substrate |
| | | layer Ta | layer Ta | layer | layer | Contact | Contact | Fe eluted |
| Test material | | content | content | residual | residual | resistance | resistance | amount |
| Classification | No. | (atomic %) | (atomic %) | ratio (%) | ratio (%) | (mΩ · cm²) | (mΩ · cm²) | (mg/m²) |
| Comparative | 1 | 0* | 0 | 30 | — | 4.3 | 4.3 | 13 |
| example | 2 | 33* | 33 | 100 | — | 5.0 | 5.2 | 10 |
| | 3 | 0* | 20 | 30 | — | 4.5 | 4.5 | 10 |
| | 4 | 20* | 20 | 100 | — | 4.7 | 4.7 | 10 |
| | 5 | 45* | 20 | 100 | 100 | 5.0 | 5.3 | 13 |
| Example | 6 | 55 | 20 | 100 | 100 | 5.0 | 5.3 | 3 |
| | 7 | 66 | 20 | 100 | 100 | 5.5 | 5.5 | <1.5 |
| | 8 | 74 | 20 | 100 | 100 | 6.0 | 6.2 | <1.5 |
| | 9 | 83 | 20 | 100 | 100 | 6.3 | 6.5 | <1.5 |
| Comparative | 10 | 100* | 20 | 100 | 80 | 8.0 | 9.5 | 6 |
| example | 11 | 100* | 0 | 100 | 10 | 5.0 | 5.5 | 6 |
| Example | 12 | 74 | 0 | 100 | 70 | 5.0 | 5.5 | <1.5 |
| | 13 | 74 | 12 | 100 | 90 | 5.2 | 4.7 | <1.5 |
| | 14 | 74 | 45 | 100 | 100 | 6.3 | 7.3 | <1.5 |
| | 15 | 74 | 55 | 100 | 100 | 6.0 | 7.0 | <1.5 |
| Comparative | 16 | 74 | 74* | 100 | — | 13 | 150 | <1.5 |
| example | | | | | | | | |

*Outside the range of the present invention

As shown in Table 1, the test materials Nos. 1 to 5 are the comparative examples wherein the content of the normoble metal element (Ta) in a corrosion resistant layer is insufficiently less than 50 atomic % and the content of the normoble metal element in a conductive layer as an upper layer is also less than 50 atomic %. As a result, the noble metal element (Au) coagulates in both the layers, hence the substrate is exposed, and Fe elutes. Meanwhile, the test materials Nos. 10 and 11 are comparative examples wherein the content of the normoble metal element in a corrosion resistant layer is excessive (no noble metal element is contained), hence the corrosion resistant layer forms the crystal structure of Ta that is a high-melting-point metal, pinholes are generated, and the substrate is exposed. On the other hand, the test materials Nos. 6 to 9 and 12 to 15 are the examples wherein the content of the normoble metal element in a corrosion resistant layer is within the range stipulated in the present invention, hence the corrosion resistant layer comprises an amorphous alloy that hardly causes pinholes, Au does not coagulate in the alloy, and the substrate is scarcely exposed. In the test materials Nos. 7 to 9 and 12 to 15 in particular, a corrosion resistant layer contains the normoble metal element exceeding 65 atomic %, hence the substrate is not exposed even in the case of a film having a thickness of 5 nm, and the eluted quantity of Fe in the substrate is lower than the measurement limit.

Further, in the test materials Nos. 6 to 9 and 12 to 15 as the examples, a conductive layer as an upper layer contains a sufficient amount of noble metal element and hence the test material shows good electrical conductivity even after it is immersed in sulfuric acid. In contrast, in the test material No. 16, the substrate is not exposed since the composition of the corrosion resistant layer is within the range stipulated in the present invention, but the test material is a comparative example wherein the content of the normoble metal element (Ta) in the conductive layer is excessive, the noble metal element is insufficient, hence the electrical conductivity is poor already at the initial stage, the excessive Ta further forms an oxide film after the test material is immersed in sulfuric acid, and the electrical conductivity further deteriorates.

In the test materials Nos. 6 to 9 and 12 to 15, a corrosion resistant layer contains the normoble metal element (Ta) and hence the adhesiveness between the corrosion resistant layer and the oxide film on the substrate surface improves due to interdiffusion caused by heat treatment. Further, by containing the noble metal element (Au) in both the corrosion resistant layer and the conductive layer and applying heat treatment after forming the corrosion resistant film, the adhesiveness between them further improves. In the test materials Nos. 6 to 9 and 13 to 15 in particular, since both a corrosion resistant layer and a conductive layer comprise an alloy of the noble metal element (Au) and the normoble metal element (Ta), the corrosion resistant film excellent in adhesiveness having a conductive layer residual ratio of 90% or more is obtained. In contrast, in the test materials Nos. 1 and 3, since a film containing only the noble metal element is formed on a substrate surface as the corrosion resistant layer, the adhesiveness is inferior. Furthermore, in the test material No. 11, since the corrosion resistant film comprises two kinds of laminated metal films; the corrosion resistant layer comprising Ta as the lower layer and the conductive layer comprising Au as the upper layer, the adhesiveness is inferior and the conductive layer as the upper layer peels off at the extraction test.

What is claimed is:

1. A corrosion resistant film for a fuel cell separator, which covers the surface of the fuel cell separator, comprising:
a corrosion resistant layer comprising an alloy of one or more kinds of noble metal elements selected from the group of Au and Pt and one or more kinds of normoble metal elements selected from the group of Nb, Ta, Zr, and Hf and containing said normoble metal elements by 50 to 90 atomic %; and
a conductive layer being laminated on said corrosion resistant layer and comprising one or more kinds of noble metal elements selected from the group of Au and Pt.

2. A corrosion resistant film for a fuel cell separator, which covers the surface of the fuel cell separator, comprising:
a corrosion resistant layer comprising an alloy of one or more kinds of noble metal elements selected from the group of Au and Pt and one or more kinds of normoble metal elements selected from the group of Nb, Ta, Zr, and Hf and containing said normoble metal elements by 50 to 90 atomic %; and
a conductive layer being laminated on said corrosion resistant layer, comprising an alloy of one or more kinds of noble metal elements selected from the group of Au and Pt and one or more kinds of normoble metal elements selected from the group of Nb, Ta, Zr, and Hf, and containing said normoble metal elements by not more than 65 atomic %.

3. A fuel cell separator formed by coating a substrate comprising one kind selected from the group of titanium, titanium alloy, aluminum, aluminum alloy, and stainless steel with a corrosion resistant film for a fuel cell separator according to claim 1.

4. A fuel cell separator formed by coating a substrate comprising one kind selected from the group of titanium, titanium alloy, aluminum, aluminum alloy, and stainless steel with a corrosion resistant film for a fuel cell separator according to claim 2.
